(19) United States
(12) Patent Application Publication
(10) Pub. No.: US 2024/0183701 A1
(43) Pub. Date: Jun. 6, 2024

(54) DETECTION OF FLUID PRODUCT USING WIRELESS BEACONS

(71) Applicant: Ecolab USA Inc., St. Paul, MN (US)

(72) Inventors: Rachel Marie McGinness, Rosemount, MN (US); Mason Alan Owens, Blaine, MN (US); Kyle D. Wood, Rosemount, MN (US)

(21) Appl. No.: 18/529,892

(22) Filed: Dec. 5, 2023

Related U.S. Application Data
(60) Provisional application No. 63/386,109, filed on Dec. 5, 2022.

(51) Int. Cl. G01F 22/00

(52) U.S. Cl. CPC G01F 22/00

(57) ABSTRACT

This disclosure describes techniques for the detection of presence or absence of a fluid product in a product container using wireless beacons. One or more wireless beacon transmitters are placed on or within a product container containing a fluid product to be dispensed. The beacon transmitter periodically broadcasts a beacon signal. The signal strength of the received beacon signal, the reception frequency of the beacon signal, and/or other parameter(s) associated with the beacon signal are indicative of an amount of fluid product in the product container.

### CROSS-REFERENCE TO RELATED APPLICATIONS

This application claims the benefit of U.S. Provisional Patent Application No. 63/386,109, filed Dec. 5, 2022, the entire contents of which are incorporated by reference herein.

### BACKGROUND

Product dispensers may be used to dispense a wide variety of fluid products. For example, fluid products in the form of liquids, gels, foams, or pastes may be manually or automatically dispensed out of product containers and used in a wide variety of cleaning, commercial, or industrial applications. In fluid delivery systems where large quantities of fluid are delivered on a frequent or continuous basis, automated dispensing systems are often used. In such examples, the product container(s) and fluid delivery medium(s) may be integrated with a device to which the fluid is delivered, such as a commercial dish or laundry machine, or may be located separately from the location where the fluid is dispensed, making it difficult to monitor the amount of fluid product remaining in the product container(s).

### SUMMARY

In general, the disclosure relates to techniques for the detection of a fluid product in a product container using wireless beacons. For example, one or more wireless beacon transmitters are placed on or within a product container containing a fluid product to be dispensed. The beacon transmitter periodically broadcasts a wireless beacon signal. The beacon signal may include, for example, beacon data including a beacon identifier and/or other beacon information associated with the beacon signal. One or more wireless beacon receivers positioned outside the product container are configured to receive the wireless beacon signals. The signal strength of the received beacon signal and/or the reception frequency of the beacon signal (and/or other parameter(s) associated with the beacon signal) is indicative of an amount of fluid product in the product container. The system analyzes the received signal strength, the reception frequency of the beacon signal, and/or other parameter(s) associated with the beacon signal to detect presence, absence, or a relative amount of fluid product in the product container. In some examples, the system generates a low product alert when a low product condition is detected and/or an out of product alert when an out of product condition is detected.

In one example, the disclosure describes a system comprising: a memory storing beacon data associated with a wireless beacon signal received from a beacon transmitter located within an interior of a product container, wherein the product container is configured to contain a fluid product to be dispensed and the beacon data includes a received signal strength parameter for the wireless beacon signal; and one or more processors coupled to the memory and configured to: determine a reception frequency of the wireless beacon signal; and detect presence or absence of the fluid product in the product container based on a determination that the received signal strength parameter of the wireless beacon signal satisfies a received signal strength threshold and a determination that the reception frequency of the beacon signal satisfies a reception frequency threshold.

In another example, the disclosure describes a method comprising: determining, by one or more processors, a reception frequency of a wireless beacon signal transmitted by a beacon transmitter located within an interior of a product container, wherein the product container is configured to contain a fluid product to be dispensed; and detecting, by the one or more processors, presence or absence of the fluid product in the product container based on a determination that a received signal strength parameter for the wireless beacon signal satisfies a received signal strength threshold and a determination that the reception frequency of the beacon signal satisfies a reception frequency threshold.

In another example, the disclosure describes a non-transitory computer-readable medium comprising instructions that when executed by one or more processors cause the one or more processors to: determine a reception frequency of a wireless beacon signal transmitted by a beacon transmitter located within an interior of a product container configured to contain a fluid product to be dispensed; and detect presence or absence of the fluid product in the product container based on a determination that a received signal strength parameter for the wireless beacon signal satisfies a received signal strength threshold and a determination that the reception frequency of the beacon signal satisfies a reception frequency threshold.

The details of one or more examples are set forth in the accompanying drawings and the description below. Other features will be apparent from the description and drawings, and from the claims.

### BRIEF DESCRIPTION OF DRAWINGS

FIG. 1 is a diagram of an example system that detects presence or absence of a fluid product in a product container using wireless beacons, in accordance with one or more techniques of the disclosure.

FIG. 2A is a block diagram of a computing device that analyzes received signal strength and/or reception frequency of a beacon signal to detect presence, absence, or an amount of fluid product in a product container, in accordance with one or more techniques of the disclosure.

FIGS. 2B and 2C are example screen shots that may be displayed on a computing device by which one or more beacon transmitters may be configured.

FIG. 3 is a diagram of an example system that detects presence or absence of a fluid product in a product container using wireless beacons, in accordance with one or more techniques of the disclosure.

FIG. 4 is a block diagram of an example user computing device including an example site status application and an example notification that may be displayed on a user computing device in accordance with one or more techniques of the disclosure.

FIG. 5 is a graph illustrating example received signal strength indicator (RSSI) data for a received beacon signal and percent fluid product remaining in a product container versus time, in accordance with one or more techniques of the disclosure.

FIG. 6 is a graph illustrating example RSSI data for a received beacon signal and fluid product weight remaining in a product container versus time, in accordance with one or more techniques of the disclosure.

FIG. 7 is a graph illustrating example RSSI data for a received beacon signal versus fluid product weight remaining in a product container, in accordance with one or more techniques of the disclosure.

FIGS. 8A and 8B are graphs of data resulting from an experimental depletion test, in accordance with one or more techniques of the disclosure.

FIG. 9 is a flowchart illustrating an example process by which a computing device detects presence or absence of a fluid product to be dispensed from a product container, in accordance with one or more techniques of the disclosure.

### DETAILED DESCRIPTION

In general, the disclosure relates to systems and methods that detect presence or absence of a fluid product in a product container using wireless beacons. For example, in accordance with one or more techniques of the disclosure, the systems and/or methods include a wireless beacon transmitter positioned on or within a product container containing a fluid product to be dispensed. The beacon transmitter periodically broadcasts a wireless beacon signal. The beacon signal may include, for example, beacon data including a beacon identifier and/or other associated beacon information (e.g., firmware version, battery level, transmit power, and/or other device information). One or more wireless beacon receivers positioned outside the product container are configured to receive the wireless beacon signals. The received signal strength, the reception frequency of the beacon signal, and/or other parameter(s) associated with the beacon signal are affected by, among other things, the amount of fluid product in the container, the transmission properties of the fluid product, the distance between the beacon transmitter and the beacon receiver, etc. The received signal strength, the reception frequency of the beacon signal, and/or other parameter(s) associated with the beacon signal are thus indicative of the amount of fluid product in the product container.

In some examples, the system analyzes the received signal strength and/or the reception frequency of the beacon signal to detect presence, absence, or an amount of fluid product in the product container. In some examples, the system detects presence or absence of the fluid product in the product container based on a determination that the received signal strength parameter of the wireless beacon signal satisfies a received signal strength threshold and a determination that the reception frequency of the beacon signal satisfies a reception frequency threshold. One or more other parameter(s) associated with the beacon signal may also be considered, and the disclosure is not limited in this respect.

In some examples, the system generates a notification indicative of an amount of fluid product remaining in the product container. The notification may include a low product alert generated based on detection of a low product condition and/or an out-of-product alert generated based on detection of an out of product condition.

In accordance with one or more techniques of the disclosure, the beacon transmitter and the beacon receiver are positioned with respect to each other such that the signal strength of the received beacon signal and/or the reception frequency of the beacon signal is indicative of the relative amount of fluid product remaining in the product container. As the fluid product is dispensed from the container and the amount of fluid in the product container decreases, the relative amount of air in the product container increases as compared to the amount of fluid product in the product container. As a result, the distance over which the beacon signal travels through the fluid product before being received by the beacon receiver decreases as the amount of fluid product in the product container decreases. Conversely, the distance over which the beacon signal travels through air before being received by the beacon receiver increases as the amount of fluid product in the container decreases.

In general, the amount of attenuation experienced by a wireless signal is a function of a distance between the transmitter and the receiver, the transmission properties of the transmission medium, as well as the frequency of the underlying wireless transmission. The attenuation experienced by a wireless beacon signal transmitted through a fluid is generally different than the attenuation experienced by a wireless beacon signal transmitted through air. In accordance with one or more techniques of the disclosure, the received signal strength of a received beacon signal is used as a basis on which to detect a low product condition, an out of product condition and/or an amount of fluid product present in a product container.

In some examples, the transmission properties of a fluid medium result in relatively greater attenuation of wireless beacon signals as compared to the transmission properties of air. This means that the attenuation experienced by a beacon signal traveling through the fluid medium is relatively greater than the attenuation experienced by the beacon signal (assuming the same frequency and transmission power) traveling through air. The signal strength of a received beacon signal traveling through a product container thus increases as the fluid product is dispensed and the amount of fluid in the product container decreases. In addition, the reception frequency of the beacon signals (i.e., the quantity of beacon signals received per unit time or the quantity of beacon signals received per unit time as compared to an expected quantity of beacon signals to be received per unit time) having a received signal strength above a predetermined threshold may also increase as the amount of fluid in the product container decreases. By analyzing the received signal strength, the reception frequency of the received beacon signals, and/or one or more other parameter(s) associated with the beacon signal, systems and/or methods implementing the techniques of the disclosure detect product presence, absence, and/or an amount of fluid product present in the product container. In some examples, the systems and/or methods generate an out of product or low product alert when one or more configurable alert thresholds are reached, to alert a user or service technician that the fluid product needs to be refilled or replaced.

In some examples, the wireless beacon transmitter(s) include low power beacon transmitter(s), such as a Bluetooth Low Energy (BLE) beacon transmitter(s), the wireless beacon signals include BLE beacon signals and the wireless beacon receivers include BLE receiver(s). However, in other examples, the beacon transmitters/receivers may be configured to communicate using any type of wireless communication, including, but not limited to, Wi-Fi (i.e., 802.11), Bluetooth, near-field communication (NFC), ZigBee, satellite, cellular, infrared, and/or any other type of wireless communication. Thus, although some example implementations discussed herein are described with respect to BLE beacons, the disclosure is not limited in this respect.

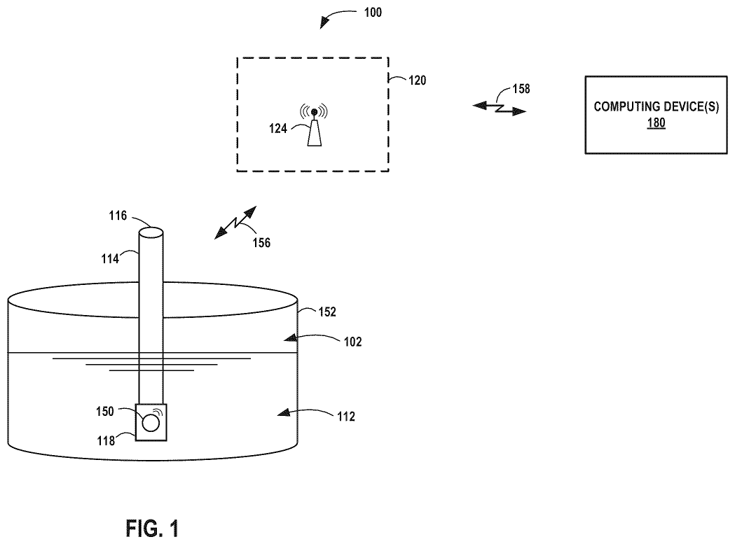

FIG. 1 is a schematic diagram of an example system 100 that detects presence or absence of a fluid product to be dispensed from a product container using wireless beacons, in accordance with one or more techniques of the disclosure. Example system 100 includes a wireless beacon transmitter 150 positioned on or within an interior 102 of a product container 152 configured to contain a fluid product 112 to be dispensed. System 100 may include one or more product containers 152, each having at least one associated beacon transmitter 150; however, a single product container 152 and beacon transmitter 150 is shown in FIG. 1 for simplicity of illustration.

In the example of FIG. 1, a hollow probe assembly 114 includes a first open end 116 and a second enclosed end 118. Probe assembly 114 is positioned within product container 152 such that second enclosed end 118 rests substantially on or near the bottom of product container 152 and first open end 116 extends above a highest fill level of fluid product 112 (e.g., a level of the fluid product when the container is “full”). Beacon transmitter 150 is positioned within hollow probe assembly 114, for example, at or near second enclosed end 118, such that beacon transmitter 150 is positioned to detect a low product or out of product condition at a desired low product or out of product fill level. In other examples, a bracket or other mechanism for holding beacon transmitter 150 in a fixed position with respect to the interior side or bottom walls of the product container 152 may be used in place of hollow probe assembly 114. In other examples, beacon transmitter 150 may be placed directly into the fluid product 112 within product container 152. In such examples, beacon transmitter 150 would sink through fluid product 112 and come to rest at the bottom of product container 152.

Beacon transmitter 150 periodically broadcasts a wireless beacon signal. The wireless beacon signal is indicated by reference numeral 156. The wireless beacon signal may include, for example, beacon data including a beacon identifier and/or other associated beacon information. One or more wireless beacon receivers, such as beacon receiver 124, are positioned outside product container 152 and are configured to receive wireless beacon signals broadcast by one or more beacon transmitters 150. In some examples, one or more beacon receivers 124 are configured as a beacon mesh network 120. Beacon mesh network 120 includes a plurality of beacon receivers 124 configured to communicate with each other and with one or more computing device(s), such as computing device(s) 180. Beacon mesh network 120 may be configured as a full mesh, wherein every node (i.e., beacon receiver) communicates with every other node, or a partial mesh, wherein each node communicates with nearby nodes. Each of the beacon receivers 124 in beacon mesh network 120 may act as a repeater to communicate beacon data associated with beacon signals received by any of the individual beacon receivers 124 to computing device(s) 180 or other destination. Although a beacon mesh network 120 is described herein, the one or more beacon receivers 124 may be configured in any type of beacon network, and the disclosure is not limited in this respect.

In some examples, upon receipt of a beacon signal, a beacon receiver 124 determines one or more parameters with respect to the received beacon signal. The parameter(s) may include, for example, a received signal strength indicator (RSSI), a signal-to-noise ratio (SNR), and/or any other measurements related to the received beacon signal. Beacon receiver 124 may further decode the beacon identifier and/or other beacon information encoded in the received beacon signal. Beacon receiver 124 and/or beacon mesh network 120 transmits beacon data 158 associated with the received beacon signal, including the beacon identifier, any other beacon information encoded in the beacon signal, a date/time stamp indicating the date and time the beacon signal was received, RSSI, SNR and/or other parameters associated with the received beacon signal, etc., to one or more computing device(s), such as computing device(s) 180. The beacon receiver 124/mesh network 120 transmits the beacon data 158 via any one or more of a wired network, a wireless network, a cellular network, the Internet, and/or any other type of electronic communication.

Computing device(s) 180 may include a local and/or a remote computing device configured to analyze beacon data 158 associated with the received beacon signals to detect presence or absence of fluid product 112 within product container 152. For example, computing device(s) 180 may determine a reception frequency of a beacon signal received from beacon transmitter 150 over one or more predetermined time periods. Computing device(s) 180 analyze the received signal strength of the beacon signal, the reception frequency of the beacon signal, and/or other beacon data to detect presence, absence, or an amount of fluid product in the product container. In some examples, computing device(s) 180 detect a low product condition, an out of product condition, or an amount of product remaining in the product container based on the analysis of the beacon data. Computing device(s) 180 may further generate one or more low product and/or out of product alert(s), and/or an amount of product remaining in the product container, for display on a user computing device when one or more configurable alert thresholds are reached, to alert a user or service technician that the fluid product needs to be refilled or replaced.

In some examples, computing device(s) 180 include one or more computer-readable storage medium(s) or memories that store beacon/product association data. The beacon/product association data associates a beacon identifier for each of one or more beacon transmitters 150 with product information associated with one or more fluid products 112 and/or product containers 152. In this way, computing device(s) 180 may decode the beacon identifier included in a received beacon signal, refer to the stored beacon/product association data, and determine product information for the product container and/or fluid product associated with the beacon transmitter that broadcast the received beacon signal.

The beacon/product association data may include, for example, an association between a beacon identifier for each of one or more beacon transmitters and a product container identifier, a product name, a product type, a location, a customer name, a site name, and/or any other information relevant to the application. The beacon/product association data may be input into computing device(s) 180 at the time of manufacture, when a product container is deployed at a site, or at any other appropriate time.

In some examples, upon detection of a low product or an out of product condition, computing device(s) 180 generate a low product or an out of product notification for display on a user computing device. In addition or alternatively, computing device(s) 180 may generate a notification indicative of the status of the fluid product within the product container determined based on the received beacon signal. The status may include, for example, a product present or “OK” status, a “low product” status, or an “out of product” status). The notification(s) may further include the beacon identification information, received beacon signal parameters, other beacon data, and/or any of the associated product data including a product container identifier, a product name, a product type, a product container location, a customer name or other customer identification information, an amount of product remaining in the product container, a recommended action, and/or any other information associated with the beacon identification information.

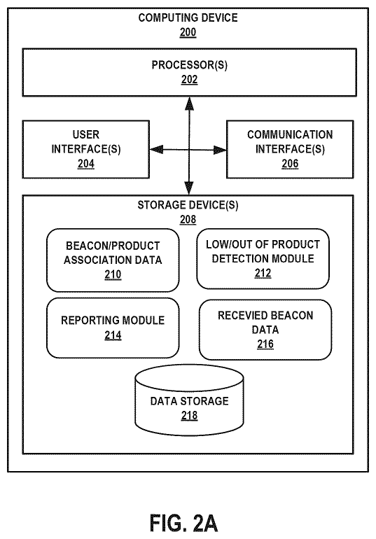

FIG. 2 is a block diagram of a computing device 200 that analyzes the received signal strength, the reception frequency of a beacon signal, and/or other parameter(s) associated with the beacon signal to detect presence, absence, or an amount of fluid product in a product container, in accordance with one or more techniques of the disclosure. Computing device 200 includes one or more processors 202, one or more user interface components 204, one or more communication components 206, and one or more data storage components or memories 208. Computing device 200 may be used to implement, for example, computing device(s) 150 as shown in FIG. 1. Although computing device 200 is illustrated as a single computing device, computing device 200 may include one or more distributed computing devices, and the disclosure is not limited in this respect.

Communication interface(s) 206 of computing device 200 receives beacon data regarding wireless beacon signals received by one or more beacon receivers, such beacon receiver 124 and/or beacon mesh network 120. The beacon data may include, for example, for each received beacon signal, a beacon identifier and/or other beacon information associated with the beacon signal, the RSSI and/or SNR of the received beacon signals, and any other information related to the beacon signal. Computing device 200 stores the received beacon data as beacon data 216.

User interface components 204 may include one or more of audio interface(s), visual interface(s), and touch-based interface components, including a touch-sensitive screen, display, speakers, buttons, keypad, stylus, mouse, or other mechanism that allows a user to interact with a computing device. Reporting module 214 generates one or more notification(s) indicative of an amount of fluid product remaining in a product container. The notification(s) may include a low product alert when a low product condition is detected and/or an out of product alert when an out of product condition is detected. Communication components 206 allow computing device 200 to communicate via wired and/or wireless communication with other electronic devices, such as a gateway/edge computing device located at or near the site, one or beacon receivers 124 and/or beacon mesh networks 120, one or more user computing device(s) and/or other local or remote or local computing devices.

Storage device(s) 208 include one or more hardware and/or non-transitory computer-readable memories that store beacon/product association data 210, a low/out of product detection module 212, a reporting module 214, product and dispenser data 216, received beacon information 218, and data storage 220. Modules 212, 214, may perform operations in accordance with one or more techniques of the disclosure using software, hardware, firmware, or a mixture of hardware, software, and firmware and/or other processing circuitry residing in and/or executed by computing device 200. In some examples, one or more of data/modules 210, 212, 214, 216, and 218 may be arranged remotely to and/or remotely accessible to processors 202, for example, as one or more network services operating in a cloud-based computing system. Any data used or generated during monitoring of beacon signal information at a site or during analysis of the beacon signal information to detect presence or absence of a fluid product may be stored in data storage 222.

In accordance with one or more techniques of the disclosure, low/out of product detection module 212 comprises computer-readable instructions that, when executed by one or more processors 202, cause processors 202 of computing device 200 to analyze received beacon signal information associated with a beacon signal to detect presence or absence of a fluid product to be dispensed from a product container. For example, analysis of the received beacon signal information may include analyzing the received signal strength information (e.g., RSSI) for a received beacon signal. In some examples, the analysis further includes determining a reception frequency for the beacon signal.

In accordance with one or more techniques of the disclosure, the reception frequency is determined based on a quantity of beacon signals received by a beacon receiver during one or more predetermined time periods and an expected quantity of beacon signals to be received during the one or more predetermined time periods. For example, to determine the reception frequency of a particular beacon signal (that is, a beacon signal having a particular beacon identifier), computing device 200, executing low/out of product detection module 212, determines a quantity of the beacon signals having a received signal strength (e.g., RSSI value) satisfying a RSSI threshold value received during a predetermined time period. In some examples, computing device 200 determines a reception frequency of the beacon signal during each of a plurality of sliding time windows, wherein each window has a width equal to the predetermined time period. The windows may be adjacent or overlapping. In other examples, computing device 200 determines a reception frequency for a particular beacon signal for as long as that particular beacon signal is received or as long as the RSSI of the received beacon signal satisfies the RSSI threshold value. The predetermined time period may be, for example, a user-configurable time period in a range from several seconds to several minutes, and may depend at least in part on the broadcast interval of the beacon signal; however, any appropriate time period may be used, and the disclosure is not limited in this respect.

In some examples, the expected quantity of beacon signals to be received during a predetermined time period depends on a broadcast interval of the beacon transmitter. In some examples, the broadcast interval is an adjustable parameter that is configured during set up of the beacon transmitter. For example, the broadcast interval may include a user-configurable value in a range from 100 milliseconds to 10,000 milliseconds. In other examples, the broadcast interval is a fixed value. However, any broadcast interval may be used, and the disclosure is not limited in this respect.

As one example, if the broadcast interval of the beacon transmitter is 200 milliseconds and the predetermined time period over which to determine the reception frequency is 2 seconds, the expected quantity of beacon signals to be received during the 2 second time period is 10 (2000/200=10).

FIGS. 2B and 2C are example screen shots 270, 272, respectively, that may be displayed on a computing device, and by which a user may configure one or more beacon transmitters. In this example, the beacon name has been configured as, “Beacon123” and the beacon interval has been set to 1000 ms (one beacon per second). A use may configure the TX Power (dB), beacon interval, RSSI at a specified distance (in air), etc. These will impact the RSSI reception frequency calculations. A user may also add, delete, or upgrade one or more beacon transmitters, configure multiple beacon transmitters (by clicking on the button labeled, “Configure this Device in Bulk”) and/or configure any other available parameter of one or more beacon transmitters.

Referring again to FIG. 2A, in some examples, to determine the reception frequency, computing device 200, executing low/out of product detection module 212, compares the quantity of beacon signals received by a beacon receiver during one or more predetermined time periods and an expected quantity of beacon signals to be received during the one or more predetermined time periods. For example, computing device 200 may determine a ratio or a percentage of the expected quantity beacon signals to be received during the one or more predetermined time periods. Continuing with the example above, if 8 beacon signals satisfying the RSSI threshold are received during the predetermined time period of 2 seconds, the percentage of beacon signals received during the 2 second time period is 80% (8 beacon signals received/10 expected beacon signals=0.80=80% of the expected quantity of beacon signals were received).

In some examples, computing device 200, executing low/out of product detection module 212, may further classify the reception frequency as one of “consistent” or “intermittent” based on the comparison. For example, when the percentage of beacon signals received during a predetermined time period satisfies a threshold value (for example, at least 80% of the expected quantity of beacon signals are received, or some other predetermined percentage), the reception frequency may be classified as “consistent.” If the quantity of beacon signals received during the predetermined time period does not satisfy the threshold quantity, (e.g., less than 80% of the expected quantity of beacon signals were received, or other predetermined percentage), the reception frequency may be classified as “intermittent.”

In accordance with one or more techniques of the disclosure, computing device 200, executing low/out of product detection module 212, analyzes received signal strength information (e.g., RSSI values) associated with a beacon signal, the reception frequency of the beacon signal, and/or one or more other parameter(s) associated with the beacon signal to detect presence or absence of a fluid product to be dispensed from a product container. In some examples, when the received signal strength information and/or the reception frequency of the beacon signal satisfies a received signal strength threshold and/or a reception frequency threshold value associated with a low product condition or an out of product condition, computing device 200 detects a low product condition or an out of product condition, respectively.

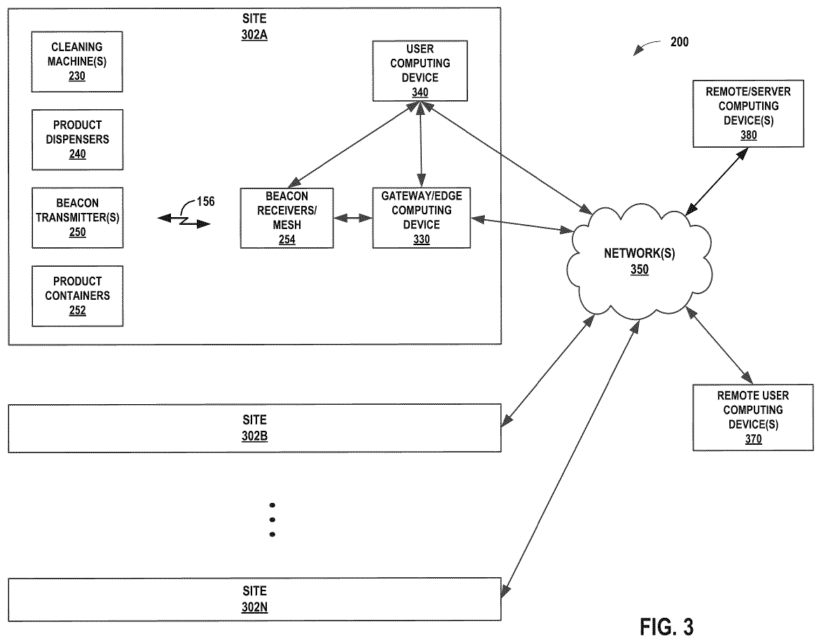

Reporting module 214 generates one or more notifications or reports for storage or for display on user interface 204, or for receipt by one or more local or remote computing device(s). In some examples, reporting module 214 generates a notification indicative of an amount of fluid product remaining in the product container for display on a user computing device. The notification may include a low product alert generated in response to detection of a low product condition and/or an out of product alert generated in response to detection of an out of product condition. In some examples, the notification may include one or more suggested actions to address a low product condition or an out of product condition. Examples of notifications that can be generated and transmitted to one or more computing devices are described with respect to FIG. 4.

Beacon product association data 210 includes a data structure storing an association between each of a plurality of beacon identifiers and a fluid product associated with the beacon identifier. The fluid product associated with a particular beacon identifier may include, for example, the fluid product contained in the product container with which the beacon transmitter is associated. The data structure of beacon/product association data 210 may include, for example, a table, a relational database, or other appropriate data structure. An example beacon/product association data table is shown in Table 1. In Table 1, each row is associated with a different beacon identifier, and each column includes fluid product information associated with the respective beacon identifier for that row.

TABLE 1

| | Product | Product | Product | Customer | | | |
|---|---|---|---|---|---|---|---|
| Beacon ID | Container ID | Type | Name | Name | Site Name | Location | Other |
| 3ce2e . . . | 2e-5fc- . . . | Detergent | UltraClean | Hotel ABC | Site123 | St. Paul, MN | . . . |
| 6dc27 . . . | 3d-5ac- . . . | Fabric Soft | SoftTouch | Hotel ABC | Site123 | St. Paul, MN | . . . |
| 1af5e . . . | 4b-9fe- . . . | Bleach | BestWhite | Hotel ABC | Site123 | St. Paul, MN | . . . |
| . . . | . . . | . . . | . . . | . . . | . . . | . . . | . . . |

By referring to the beacon/product association data 210 corresponding to a beacon ID of a received beacon signal, computing device 200 may generate notifications including any one or more of a beacon identifier, a product container identifier, a product name, a product type, a customer name, a site name, a location, and any other associated beacon data stored in beacon/product association data 210. The notification(s) may further include an amount of product remaining in the product container, a low product alert, an out of product alert, a time/date stamp, one or more recommended actions, a list of one or more parts or supplies suggested to execute the one or more recommended actions, and any other information related to presence or absence of fluid product in the product container. Other notifications associated with detected out of product conditions, notifications concerning an amount of product remaining in a product container, recommended actions, or other notifications may also be generated and displayed, and the disclosure is not limited in this respect.

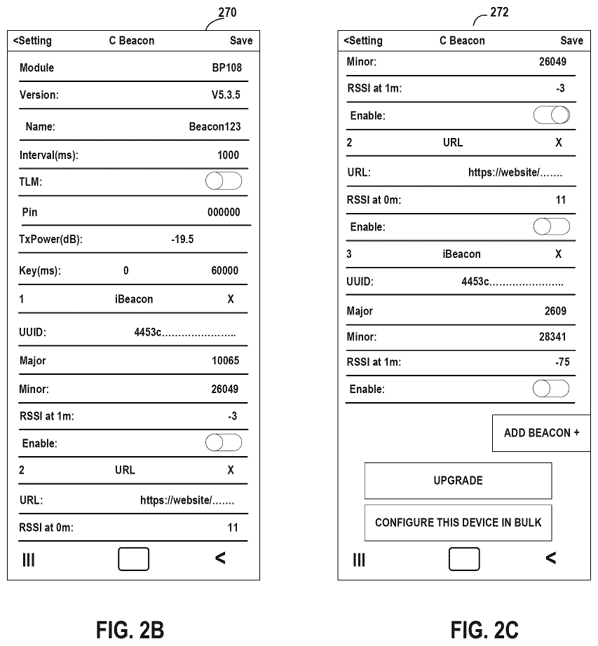

FIG. 3 is a diagram of an example system 300 that detects presence or absence of a fluid product in a product container using wireless beacons, in accordance with one or more techniques of the disclosure. In this example, each of one or more sites 302A-302N includes one or more product dispensers 240 configured to automatically dispense fluid product(s) from one or more product container(s) 252 to one or more destinations at the site. The destinations may include, for example one or more cleaning machines 230 or an end use container, such as a spray bottle, bucket, pail, other end use container into which the fluid product is dispensed. Although a specific example of automated dispensing for cleaning machine applications is described herein for purposes of discussion, the techniques of the disclosure are applicable to any other applications in which presence or absence of a fluid product is to be detected, and the disclosure is not limited in this respect.

Each product container 252 is associated with at least one beacon transmitter 250. For example, each product container 252 includes at least one beacon transmitter 250 located within an interior of the product container 252.

Each site 302A-302N includes one or more beacon receivers and/or beacon mesh networks 254 and a gateway/edge computing device 330. In some examples, gateway/edge computing device 330 is physically located at or near one or more site(s) 302A-302N to provide edge computing advantages such as increased processing speed and lower latency. One or more mobile user computing devices 340 may also be present at each site 302A-302N at various times. For example, a field service technician having an associated computing device 340, such as smart phone, tablet computing device, etc., may be present at one or more of sites 302A-302N during performance of a site visit.

In general, each gateway/edge computing device 330 provides connectivity between devices 230, 240, 250 located at the associated site 302A-302N with one or more local or remote computing devices 340, 370, 380 via a wired or wireless connection or via one or more network(s) 350. Network(s) 350 may include, for example one or more local area networks (LANs), wireless local area networks (WLANs), virtual private networks (VPNs), wide area networks (WANs), the Internet, etc. As such, gateway/edge computing device 330 is configured to communicate with beacon mesh network 254 and to transmit beacon data associated with beacon signals received from beacon transmitters 250 to one or more local and/or remote computing devices 340, 370, 380. Gateway/edge computing device 330 may be further configured to communicate with the controller(s) of the cleaning machine(s) 304, controller(s) of the product dispenser(s) 308, and/or with any other devices located at the associated site 302A-302N.

Any one or more of computing devices 340, 370, and/or 380 may be configured to execute the modules and provide the functionality described with respect to computing device 200, and may thus include low/out of product detection module 212, beacon/product association data 210, reporting module 214 and received beacon data 216.

User computing device 340 includes any type of computing device associated with a field service technician, territory manager (TM) or other person responsible for servicing cleaning machines 230, product dispensers 240, product containers 252, and/or other equipment at the site. User computing device 340 may include, for example, any type of mobile computing device such as a smart phone, tablet computer, personal digital assistant, laptop computing device, etc. User computing device 340 may also include any type of local computing device present at the site such as one or more laptop or desktop computers associated with employees or other users at the site.

In some examples, based on detection of a low product or out of product condition, a computing device, such as any of gateway/edge computing device 330, remote/server computing device 380 and/or remote user computing device 370, automatically generates a notification indicative of a low product or out of product condition. In addition or alternatively, any one or more of computing devices 330, 370, 380 may automatically generate a notification indicative of an amount of fluid product remaining in a product container for receipt by user computing device 340. The notification(s) may be generated periodically, on a scheduled basis, or on demand. The notifications may be generated for receipt by user computing device 340 associated with a service technician or other persons responsible for maintaining the equipment at the site 302. The automated notifications help to ensure that low product and/or out of product conditions are promptly communicated to the appropriate person(s) so that supplies of fluid products are efficiently replenished before the fluid product is depleted. By helping to ensure that an adequate supply fluid product is always available to be dispensed, the techniques of the disclosure further help to achieve a high standard of cleaning performance with each cleaning cycle. Further, automatic notification of low product and/or out of product conditions reduces performance of unnecessary or inefficient activities such as repeated manual checking of fluid levels and associated site visits, saving time and cost and increasing operational efficiency.

In addition or alternatively, based on detection of a low product or out of product condition, a computing device, such as computing device 330, 370, 380 may automatically generate control signals for receipt by any one or more of product dispensers 240 and/or cleaning machines 230 to automatically stop dispensation of one or more fluid products or execution of cleaning cycles when an out of product event is detected. Upon replenishment of the fluid supply, a user may restart or initiate the cleaning and/or product dispense cycles. Alternatively, receipt of a low product or out of product notification may initiate an automatic refill cycle after which the low product or out of product alert would be cleared and the cleaning and/or product dispense cycles are automatically started again.

FIG. 4 is a block diagram of an example user computing device 400 including an example site status application 408 and an example notification 402 that may be displayed on user computing device 400 in accordance with one or more techniques of the disclosure. User computing device includes one or more processors 402, a user interface 404, communication module 412, one or more data storage device or memories 405, and a power supply 414. Data storage devices 405 store a site status application 408 and data 410. User computing device 400 may be used to implement user computing device(s) 340 and/or 370 as shown in FIG. 3.

In some examples, the techniques of the present disclosure for detection of fluid product presence or absence using wireless beacons form part of a cleaning performance platform with the goal of providing insights into various aspects of cleaning performance and ensuring consistently high levels of cleaning performance for cleaning machines deployed at a plurality of sites. In a commercial laundry or dish machine application, for example, the cleaning performance platform seeks to ensure consistently clean loads of laundry or racks of dishes at each of a plurality of customer sites. The cleaning performance platform may include, for example, acoustic monitoring techniques, machine vision techniques enabled by cameras installed within or outside the washing chamber of the cleaning machines, use of washer indicators (e.g., coupon indicators), and other techniques for monitoring cleaning performance of a cleaning machine. By detecting fluid product low and/or out of product conditions and generating appropriate notifications, the techniques of the present disclosure help ensure that supplies of fluid products to be dispensed are efficiently maintained, that sufficient amounts of fluid product are present in the product containers and available to be dispensed when needed, so that a desired level of cleaning performance is reliably and consistently achieved.

As shown in FIG. 4, an example user interface 404 of user computing device 400 includes a touch screen display 420 on which one or more interactive pages generated by site status application 408 may be displayed. In this example, a low product alert notification 402 includes information generated by low/out of product detection module 210 executed by a computing device (e.g., any one of computing devices 280, 330, 380, 370) for display on user computing device 400 as described herein, in accordance with one or more techniques of the disclosure. The interactive pages enable a user (e.g., service technician, territory manager, etc.) to view notifications and/or interact with low/out of product detection module 210 and/or other computing device to obtain a fluid presence/absence information and/or other cleaning performance information concerning one or more cleaning machines at the sites.

Example low product alert notification 402 may be automatically generated by a computing device, such as computing device 200 executing low/out of product module 212, based on detection of a low product condition. Low product alert notification 402 includes a name of the site (“Hotel ABC”) at which the low product condition was detected, a site name and location (“Site123, St. Paul, MN”), a date and time associated with detection of the low product condition (“05-07-2022 02:35:14”), a product name (“UltraClean Detergent”), a product container ID (“2e-5fc . . . ”), a Beacon ID (“3ce2e . . . ”), an amount of fluid product remaining in the container (“<10%”), a number of cycles remaining (“23”), one or more recommended actions (“Replace or Refill Product Container”), and a list of one or more parts or supplies suggested to perform the one or more recommended actions (“UltraClean Detergent, 15 gal”).

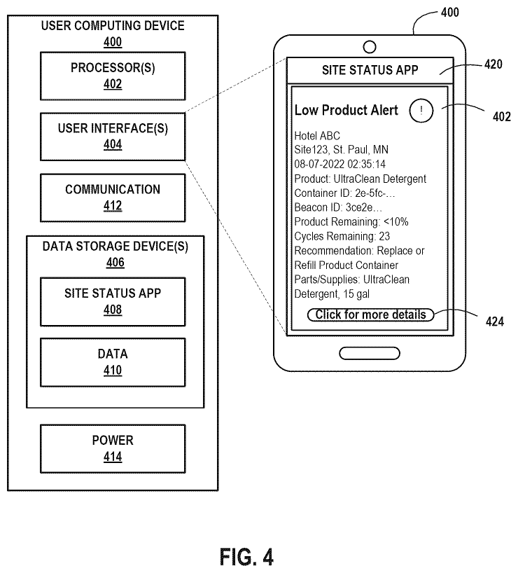

Notification 402 may include the product container ID, which helps the user to identify which product container needs to be refilled or replaced. The number of cycles remaining and/or the amount of fluid product remaining in the container may assist a user in determining when to schedule a site visit for purposes of refilling or replacing the product container. In some examples, notification 402 may further include a date/time of an automatically scheduled site visit for purposes of refilling or replacing the product container, or a user-selectable list of proposed dates/times for such a site visit. By clicking on the user-selectable button 424 labeled “Click for more details,” the user may view additional information associated with the low product notification including but not limited to a graph of received beacon signals associated with the low product notification 402, signal strength information for the received beacon signals, and/or reception frequency of the received beacon signals, such as those shown in FIGS. 5-8.

Although an example low product notification 402 is shown in FIG. 4, other notifications corresponding to detected out of product conditions, notifications concerning an amount of product remaining in a product container (expressed as, for example, a percentage, weight, volume, etc.), or other notifications may also be generated and displayed, and the disclosure is not limited in this respect.

FIGS. 5-7 are graphs of experimental data illustrating relationships between received signal strength (i.e., RSSI) of received beacon signals and amounts (e.g., percentage and/or weight) of a fluid product in a product container, in accordance with one or more techniques of the disclosure. A designed experiment was performed in which a 5 gallon (about 20 kilograms) pail was placed on top of a lab scale. Water was filled to various levels and the weight of the water was recorded. A BLE beacon having a beacon interval of 100 milliseconds was dropped into the pail. The BLE beacon was at rest at the bottom of the bucket during the experiment. A BLE receiver (a smart phone) was held about 2.5 feet above the top of the pail.

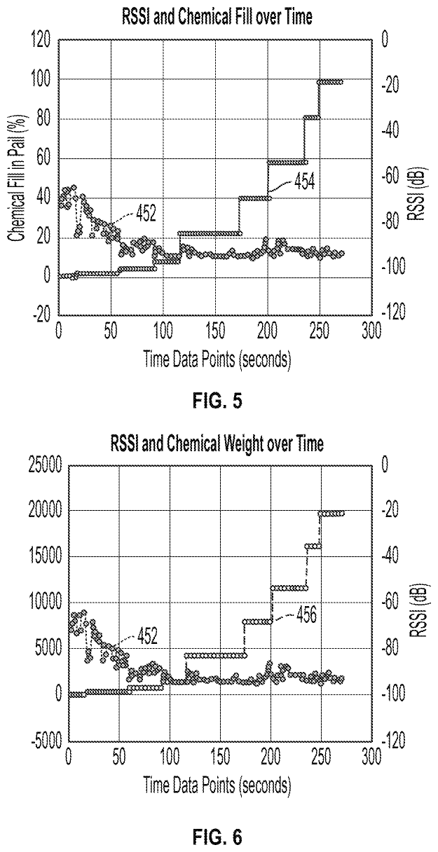

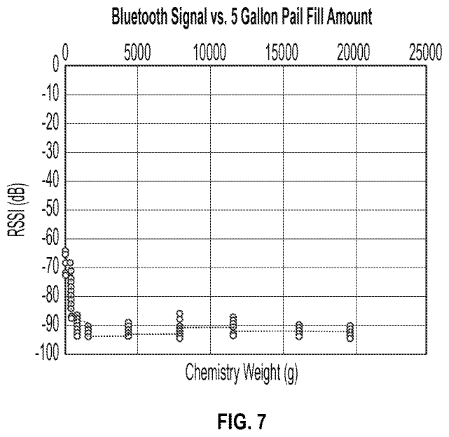

FIG. 5 is a graph of the experimental received signal strength indicator (RSSI) data for the received beacon signal and percent fluid product remaining in the product container versus time. The RSSI data is indicated by reference numeral 452 and the percentage of fluid product remaining is indicated by reference numeral 454. FIG. 6 is a graph of the experimental RSSI data for the received beacon signal and fluid product weight remaining in the product container versus time. The RSSI data (the same data as that shown in FIG. 5) is indicated by reference numeral 452 and the weight of the fluid product remaining in the pail is indicated by reference numeral 456. FIG. 7 is a graph of the experimental RSSI data for the received beacon signal versus weight of fluid product remaining in the pail.

As shown in FIGS. 5-7, the RSSI of the received beacon signal varied with the amount of fluid in the container. When the fluid level in the product container was below about 10% (about 2000 grams), the RSSI of the received beacon signals was generally greater than about −80 dB. When the fluid level in the product container was above about 10%, the RSSI of the received beacon signals was generally less than about −80 dB.

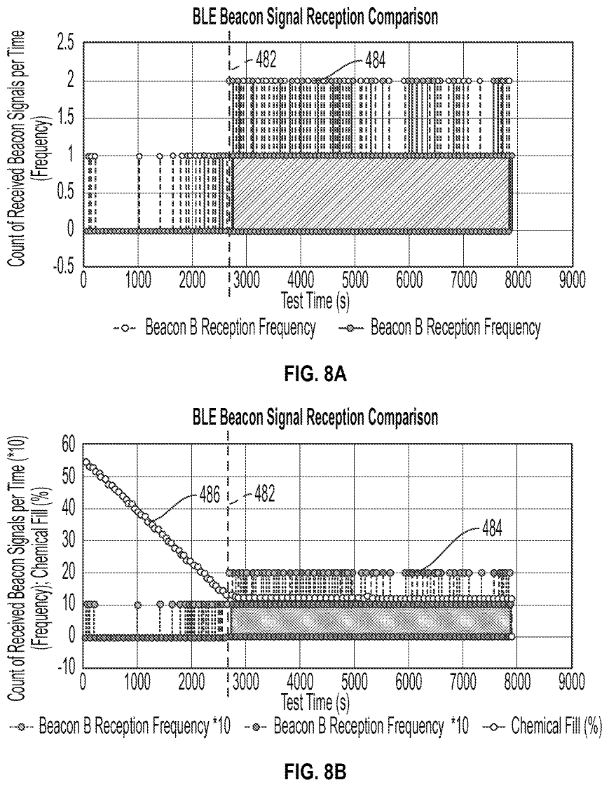

FIGS. 8A and 8B are graphs of data resulting from an experimental depletion test. FIG. 8A shows beacon count (frequency of reception) data 484 of received beacon signals for 2 beacons (labeled “Beacon B” and “Beacon C”) versus time. FIG. 8B shows the % chemical fill remaining in the bucket 486 versus time overlayed on the beacon count data 484 of FIG. 8A. In FIG. 8B, the beacon count data is multiplied by a factor of 10 for ease of illustration. For purposes of the experiment, the beacon interval was set to 1000 milliseconds and the mass of the fluid (in grams) was logged every 2 seconds. The expected beacon count was therefore 2 beacon signals for each 2 second time period. The experiment started with ˜50% fill (2.5 gallons of a 5 gallon bucket). A count of received beacon signals was determined for every time stamp logged for the mass of chemistry. As shown in FIG. 8B, very few beacon signals were received until the bucket was depleted to about 30%. Once 10% fill level was reached, the receiver started to consistently receive 1 signal every second. In this particular experimental set up, the bucket doesn't really ever fully deplete, which is why the % fill hovers just below 10%.

In some examples, the point at which consistent beacon signals are received is used as an out of product or a low product threshold, and the system generates an out of product or a low product notification. In other examples, the signal count may be aggregated over a predetermined number of time intervals to identify out of product at various levels (e.g., 5%, 10%, 15%, 20% etc.).

Computing device(s) 180 may determine a reception frequency of a beacon signal over one or more predetermined time periods. As mentioned above, the reception frequency may indicate whether reception of the beacon signal was “consistent” or “intermittent.” For example, to determine the reception frequency of a particular beacon signal (that is, a beacon signal having a particular beacon identifier), a computing device, such as computing device 200 executing low/out of product detection module 212, determines a quantity of the beacon signals having a received signal strength (e.g., RSSI value) satisfying a RSSI threshold value received during a predetermined time period as described above with respect to FIG. 2.

In the experimental results shown in FIG. 8A-8B, the reception frequency of the beacon signal at chemical fill levels at or below about 10% may be classified as “consistent” (e.g., at least a predetermined percentage of an expected quantity of beacon signals were received over one or more predetermined time periods). The reception frequency of the beacon signal at chemical fill levels greater than about 10% may be classified as “intermittent” (e.g., the received quantity of beacon signals did not satisfy the predetermined percentage of the expected quantity of beacon signals).

In other examples, instead of or in addition to determining a percentage, one or more thresholds or counts may be used. For example, a first threshold may be set such that if a count of beacon signals received during a predetermined period of time satisfies the first threshold, the reception frequency is classified as consistent. A second threshold may be set such that if a count of beacon signals received during a predetermined period of time satisfies the second threshold, the reception frequency is classified as intermittent. In other examples, a count function may be implemented. For example, the computing device(s) may count beacon signals received during each of a plurality of time cycles. A maximum number of beacon signals that can be received during each time cycle may be set such that if the maximum number is reached, the frequency of reception of the beacon signal is classified as consistent. If the maximum number is not reached, the frequency of reception of the beacon signal is classified as intermittent.

The beacon count, time periods over which the reception frequency is determined, count values, thresholds, the percentage or weight of product remaining at which an out of product or low product threshold is set, and other variables may be changed based on the particular application, the chemical product to be dispensed, the desired notification levels, etc., and the disclosure is not limited in this respect.

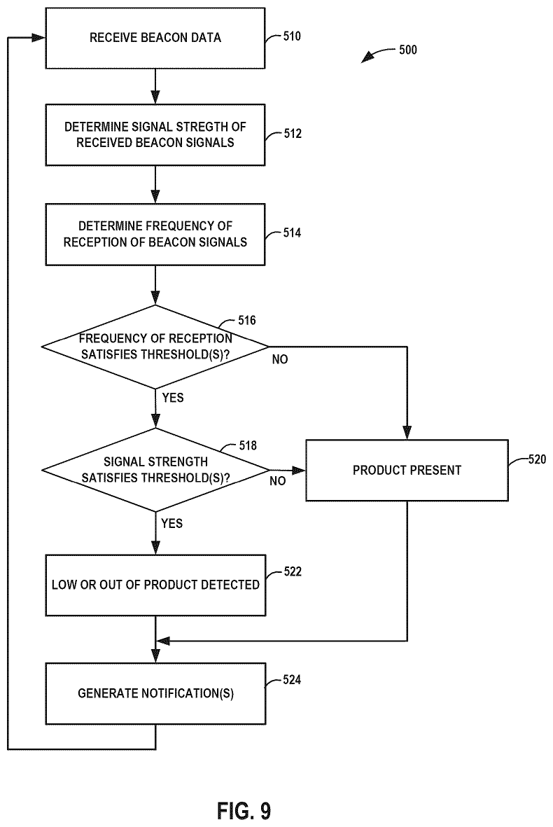

FIG. 9 is a flowchart illustrating an example process (500) by which a computing device detects presence or absence of a fluid product to be dispensed from a product container based on wireless beacon signals received from one or more beacon transmitters, in accordance with one or more techniques of the disclosure. The computing device may include, for example, any one or more of computing devices 180, 200, 330, 340, 370, or 380, executing low/out of product detection module 212.

The computing device receives beacon data associated with one or more received wireless beacon signals transmitted by a beacon transmitter located within an interior of a product container configured to contain a fluid product to be dispensed (510). The beacon data may include, for example, the beacon identifier, other beacon information encoded in the beacon signal, a received signal strength indicator (RSSI), a time/stamp time of reception of the beacon signal, a signal-to-noise ratio (SNR), and/or any other parameter(s) related to the received beacon signal. The computing device may determine a signal strength parameter (e.g., RSSI, SNR, and/or other parameter(s) indicative of the signal strength and/or quality of the received beacon signal) (512). Alternatively, the signal strength parameter(s) may be determined by beacon receiver 124 or beacon mesh network 120 that received the wireless beacon signal and transmitted to the computing device as part of the beacon data.

The computing device determines a reception frequency of the received wireless beacon signal (514). In some examples, the reception frequency of a beacon signal is determined based on a quantity (e.g., a count) of beacon signals received by a beacon receiver during one or more predetermined time periods and an expected quantity (e.g., an expected count) of beacon signals to be received during the one or more predetermined time periods. In some examples, the count may be aggregated over one or more predetermined time periods (such as 30 seconds, one minute, two minutes, etc.) and the count compared to an expected aggregated count over the one or more predetermined time periods.

The computing device compares the reception frequency to one or more reception frequency threshold(s). The one or more reception frequency threshold(s) may include, for example, a low product reception frequency threshold and/or an out of product reception frequency threshold. If the reception frequency of the wireless beacon signal does not satisfy the low or out of product reception frequency threshold(s) (NO branch of 516), the computing device determines that the amount of product in the product container does not satisfy a corresponding low or out of product condition, and that a sufficient amount of fluid product is present in the product container (520).

If the reception frequency of the beacon signal satisfies one of the low or out of product reception frequency threshold(s) (YES branch of 516), the computing device determines whether the signal strength parameter satisfies one or more signal strength threshold(s) (518). The one or more signal strength threshold(s) may include, for example, a low product signal strength threshold and/or an out of product signal strength threshold. If the signal strength of the received beacon signal does not satisfy one of the signal strength threshold(s) (NO branch of 518), the computing device determines that the amount of product in the product container does not satisfy a low or out of product condition, and that a sufficient amount of fluid product is present in the product container (520). If the signal strength of the received beacon signal satisfies one of the low or out of product signal strength threshold(s) (YES branch of 518), the computing device detects a corresponding low or out of product condition (522).

The computing device may further generate one or more notifications indicative of presence or absence of fluid product in the product container (524). For example, upon detection of a low product or an out of product condition, the computing device may generate a low product or an out of product notification, respectively, for display on a user computing device. In addition or alternatively, the computing device may generate a notification indicative of the status of the product container (e.g., product present or “OK”, low product, or out of product). The notification(s) may further include any one or more of the beacon identifier, other beacon data encoded in the received beacon signal, and/or one or more received beacon signal parameters such as received signal strength, signal to noise ratio, etc. The notification(s) may further include one or more of the product data associated with the beacon signal including a product container identifier, a product name, a product type, a product container location, a customer name or other customer identification information, and/or any other information associated with the beacon identification information. In some examples, the notification may include one or more recommended actions that may be taken to address a low product condition or an out of product condition.

Although the examples presented herein are described with respect to automated cleaning machines for use in food preparation/processing or laundry applications (e.g., dish machines, commercial laundry machines, etc.), it shall be understood that the techniques described herein may be applied to a wide variety of other commercial and industrial applications in which fluid products are dispensed.

In one or more examples, the functions described herein may be implemented in hardware, software, firmware, or any combination thereof. If implemented in software, the functions may be stored on or transmitted over, as one or more instructions or code, a computer-readable medium or memory and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise any one or more of random access memory (RAM), read only memory (ROM), electrically erasable programmable read only memory (EEPROM), compact disk read only memory (CD-ROM) or other optical disk storage, magnetic disk storage or other magnetic storage devices, solid state device, flash memory, or any other medium that can be used to store desired program code in the form of instructions or data structures and that can be accessed by a computer, one or more processors or processing circuitry. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by any type of processing circuitry including one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A system comprising:
a memory storing beacon data associated with a wireless beacon signal received from a beacon transmitter located within an interior of a product container, wherein the product container is configured to contain a fluid product to be dispensed and the beacon data includes a received signal strength parameter for the wireless beacon signal; and
one or more processors coupled to the memory and configured to:
determine a reception frequency of the wireless beacon signal; and
detect presence or absence of the fluid product in the product container based on a determination that the received signal strength parameter of the wireless beacon signal satisfies a received signal strength threshold and a determination that the reception frequency of the beacon signal satisfies a reception frequency threshold.

2. The system of claim 1, wherein to determine the reception frequency of the wireless beacon signal, the one or more processors are further configured to:
compare a quantity of the wireless beacon signals received over a predetermined time period with an expected quantity of wireless beacon signals to be received over the predetermined time period.

3. The system of claim 1, wherein the expected quantity of wireless beacon signals to be received over the predetermined time period is based on a broadcast interval of the beacon transmitter.

4. The system of claim 1, wherein to determine whether the reception frequency of the beacon signal satisfies the reception frequency threshold, the one or more processors are further configured to:
determine whether a quantity of wireless beacon signals received over a predetermined time period satisfies a threshold percentage of an expected quantity of wireless beacon signals expected to be received over the predetermined time period.

5. The system of claim 1, wherein the one or more processors are further configured to:
automatically generate, for display on a user computing device, a notification indicative of presence or absence of the fluid product in the product container.

6. The system of claim 5, wherein the notification includes one or more of a beacon identifier associated with the wireless beacon signal, a product container identifier uniquely identifying the product container, and a product name associated with the fluid product.

7. The system of claim 1, wherein the one or more processors are further configured to:
detect an out of product condition based on a determination that the received signal strength parameter for the wireless beacon signal satisfies an out of product signal strength threshold and on a determination that the reception frequency of the beacon signal satisfies an out of product reception frequency threshold.

8. The system of claim 7, wherein the one or more processors are further configured to:
automatically generate, for display on a user computing device, a notification indicative of the detected out of product condition.

9. The system of claim 1, wherein the one or more processors are further configured to:
detect a low product condition based on a determination that the received signal strength parameter for the beacon signal satisfies a low product signal strength threshold and on a determination that the reception frequency of the beacon signal satisfies a low product reception frequency threshold.

10. The system of claim 9, wherein the one or more processors are further configured to:
automatically generate, for display on a user computing device, a notification indicative of the detected low product condition.

11. A method comprising:
determining, by one or more processors, a reception frequency of a wireless beacon signal transmitted by a beacon transmitter located within an interior of a product container, wherein the product container is configured to contain a fluid product to be dispensed; and
detecting, by the one or more processors, presence or absence of the fluid product in the product container based on a determination that a received signal strength parameter for the wireless beacon signal satisfies a received signal strength threshold and a determination that the reception frequency of the beacon signal satisfies a reception frequency threshold.

12. The method of claim 11, wherein determining the reception frequency of the wireless beacon signal further includes:
compare a quantity of the wireless beacon signals received over a predetermined time period with an expected quantity of beacon signals to be received over the predetermined time period.

13. The method of claim 11, wherein the expected quantity of beacon signals to be received over the predetermined time period is based on a broadcast interval of the beacon transmitter.

14. The method of claim 11, wherein determining whether the reception frequency of the beacon signal satisfies the reception frequency threshold further includes:
determining whether a quantity of beacon signals received over a predetermined time period satisfies a threshold percentage of an expected quantity of beacon signals expected to be received over the predetermined time period.

15. The method of claim 11, further comprising:
automatically generating, by the one or more processors and for display on a user computing device, a notification indicative of presence or absence of the fluid product in the product container.

16. The method of claim 15, wherein the notification includes one or more of a beacon identifier associated with the wireless beacon signal, a product container identifier uniquely identifying the product container, and a product name associated with the fluid product.

17. The method of claim 11, further comprising:
detecting an out of product condition based on a determination that the received signal strength parameter for the wireless beacon signal satisfies an out of product signal strength threshold and on a determination that the reception frequency of the wireless beacon signal satisfies an out of product reception frequency threshold.

18. The method of claim 17, further comprising:
automatically generating, by the one or more processors and for display on a user computing device, a notification indicative of the detected out of product condition.

19. The method of claim 11, wherein the one or more processors are further configured to:
detect a low product condition based on a determination that the received signal strength parameter for the beacon signal satisfies a low product signal strength threshold and on a determination that the reception frequency of the beacon signal satisfies a low product reception frequency threshold.

20. A non-transitory computer-readable medium comprising instructions that when executed by one or more processors cause the one or more processors to:
determine a reception frequency of a wireless beacon signal transmitted by a beacon transmitter located within an interior of a product container configured to contain a fluid product to be dispensed; and
detect presence or absence of the fluid product in the product container based on a determination that a received signal strength parameter for the wireless beacon signal satisfies a received signal strength threshold and a determination that the reception frequency of the beacon signal satisfies a reception frequency threshold.
